(19) United States
(12) Patent Application Publication
(10) Pub. No.: US 2025/0106281 A1
(43) Pub. Date: Mar. 27, 2025

(54) LATENCY-EFFICIENT REDESIGNS FOR STRUCTURED, WIDE-AREA PEER-TO-PEER NETWORKS

(71) Applicant: Ohio State Innovation Foundation, Columbus, OH (US)

(72) Inventors: Shaileshh BOJJA VENKATAKRISHNAN, Hilliard, OH (US); Yunqi ZHANG, Columbus, OH (US)

(21) Appl. No.: 18/832,650

(22) PCT Filed: Jan. 25, 2023
(86) PCT No.: PCT/US2023/061243

§ 371 Date: Jul. 24, 2024

Related U.S. Application Data
(60) Provisional application No. 63/302,663, filed on Jan. 25, 2022.

(51) Int. Cl. H04L 67/1061; H04L 45/121

(52) U.S. Cl. CPC H04L 67/1065; H04L 45/121

(57) ABSTRACT

Disclosed herein is “Kadabra,” a decentralized. adaptive algorithm for selecting routing table entries in Kademlia to minimize object lookup times while being robust against Sybil attacks. Kadabra implements a multi-armed bandit (MAB) problem. with each Kademlia node acting as an independent MAB player and the node's routing table configurations being the arms of the bandit problem. By balancing exploring new routing table configurations with exploiting known configurations, a node adaptively discovers an efficient routing table that provides fast lookups. The methods described herein are fully decentralized, relying only on local timestamp measurements for feedback at each node and does not require any cooperation between nodes.

### CROSS-REFERENCE TO RELATED APPLICATION

This application claims priority to U.S. Provisional Patent Application No. 63/302,663, filed Jan. 25, 2022, entitled “LATENCY-EFFICIENT REDESIGNS FOR STRUCTURED, WIDE-AREA PEER-TO-PEER NETWORKS,” the disclosure of which is expressly incorporated herein by reference in its entirety.

### BACKGROUND

Large communication delays due to poor topology designs is a problem not only on unstructured blockchain overlays, but also on structured overlays. Many decentralized applications today rely on a structured construction (e.g., using Kademlia) to realize unicast and broadcast communication primitives. However, structured constructions also fail to take in to account the physical location of different servers while selecting neighbors in a principled way. Kademlia is well-known protocol for realizing a structured p2p system on the Internet today. In a Kademlia network, each node is assigned a unique binary node ID from a high-dimensional space (e.g., 20-byte node IDs are common). When the network size is large, it is difficult for a node to know the node ID of every single node in the network. A node may have knowledge of node IDs of only a small number (such as logarithmic in network size) of other nodes. The most basic operation supported by Kademlia is keybased routing (KBR) wherein given a key from the node ID space as input to a node, the protocol determines a routing path from the node to a target node whose ID is the ‘closest’ to the input key. Closeness between a key and a node ID in Kademlia is measured by taking the bitwise-XOR between the two binary strings and converting the resultant string as a base-10 integer. The basic KBR primitive can be used to realize higher-order functions such as a distributed hash table (DHT). In a DHT, a (key, value) store is distributed across nodes in the network. A (key, value) pair is stored at a node whose node ID is the closest to the key according to the XOR distance metric. To protect against node failures, in practice a copy of the (key, value) is also stored at a small number (e.g., 20) of sibling nodes that are nodes whose IDs are closest to the initial storing node.

To store a (key, value) in the network a node invokes a Store (key, value) remote procedure call (RPC), and to fetch a value corresponding to a key the node calls a FindValue (key) RPC. KBR is implemented as a FindNode (key) RPC, which returns the Kademlia node having the closest ID to key. Each Kademlia node maintains a routing table containing node ID, IP address and port information of other peers using which Store, FindValue or FindNode queries are routed to their appropriate target nodes. For node IDs that are n bits long, the routing table at each node comprises of n k-buckets, where each k-bucket contains information about k peers. With reference to FIG. 1A, the IDs of peers in the i-th k-bucket of a node's routing table share the first i−1 bits with the node's ID, while differing in the i-th bit. For a network with m nodes, it can be shown that on average only the first log(m) k-buckets can be filled with peer entries while the remaining k-buckets are empty due to lack of peers satisfying the prefix constraints.

Queries in Kademlia are routed either recursively or iteratively across nodes. In a recursive lookup, a query is relayed sequentially from one node to the next until a target node is found. The response from the target node is then relayed back on the reverse path to the query initiator. With reference to FIG. 1B, in an iterative lookup, a query initiating node itself sequentially contacts nodes until a target node is found and receives a response directly from the target node. When a query for key x is received at a node v, the node searches for a peer v′ within its routing table with an ID that is closest to x. If the distance between the IDs x and v′ is less than the distance between x and v, then v forwards the query to node v′. Later when v receives a response to the query from v′, v relays the response back to the node from whom it received the query. If the distance between x and v is less than a distance between x and v′, the node v issues an appropriate response for the query to the node from whom v received the query. To avoid lookup failures, a query initiator issues its query along a (e.g., a=3) independent paths. This basic lookup process described above is fundamental to implementing the Store, FindValue and FindNode functions.

A problem in prior approaches is lookup latency and node geography. A Kademlia node may include any peer it has knowledge of within its k-buckets, provided the peer satisfies the required ID prefix conditions for the k-bucket. Nodes get to know of new peers over the course of receiving queries and responses from other nodes in the network. As node IDs are assigned to nodes typically in a way that is completely independent of where the nodes are located. In today's Kademlia it is likely that the peers within a k-bucket belong to diverse geographical regions around the world without any useful structure. For example, a recent study measuring performance on the IPFS network reports a 90th percentile content storing latency of 112 s with 88% of it attributed to DHT routing latency. For retrieving content, the reported 90th percentile delay is 4.3 s which is more than 4 times the latency of an equivalent HTTPS lookup. Similar observations have been made on other Kademlia systems in the past as well.

There has been an extensive amount of work on reducing lookup latencies in DHTs by taking the physical location of nodes on the underlay. For instance, one proposed algorithm takes the ISPs of nodes into consideration, and also uses network coordinates for reducing latencies. Another tuned the number of parallel lookup queries sent or bucket size to achieve speedup. Yet another minimized the mismatch between Kademlia's logical network and the underlying physical topology through a landmark binning algorithm and RTT detection. Still others did a systematic comparison of proximity routing and proximity neighbor selection on different DHT protocols. The algorithms proposed are not tuned to the various heterogeneities in the network. Moreover, there is no regard for security in these proposed methods. As such, the proposals have not been adopted.

As noted above, security in Kademlia networks is an another problem. A Kademlia node is susceptible to various attacks, especially in permissionless settings. For example, in an Eclipse attack, an attacker blocks one or more victim nodes from connecting to other nodes in the network by filling the victim nodes' routing table with malicious nodes. In a Sybil attack, the attacker creates many fake nodes with false identities to spam the network, which may eventually undermine the reputation of the network. Today's Kademlia implementations attempt to circumvent these attacks using ideas largely inspired from S/Kademlia. In S/Kademlia, the network uses a supervised signature issued by a trustworthy certificate authority or a proof-of-work puzzle signature to restrict users' ability to freely generate new nodes.

In Kademlia, a malicious node within an honest node's routing table may route messages from the honest node to a group of malicious nodes. This attack is called adversarial routing, and it may cause delays and/or make the queries unable to find their target keys. To alleviate adversarial routing, S/Kademlia makes nodes use multiple disjoint paths to lookup contents at a cost of increased network overhead. Attackers can also enter and exit the network constantly to induce churns to destabilize the network. Kademlia networks attempt handle these kind of attacks by favoring long-lived nodes.

In another aspect, decentralized peer-to-peer applications (dapps) fueled by successes in blockchain technology are rapidly emerging as secure, transparent and open alternatives to conventional centralized applications. Today dapps have been developed for a wide gamut of application areas spanning payments, decentralized finance, social networking, healthcare, gaming etc., and have millions of users and generate billions on dollars in trade. These developments are part of a growing movement to create a more “decentralized Web”, in which no single administrative entity (e.g., a corporation or government) has complete control over important web functionalities (e.g., name resolution, content hosting, etc.) thereby providing greater power to application end users.

An operation in dapps is secure, reliable data storage and retrieval. Over the past two decades, the cloud (e.g., Google, Facebook, Amazon) together with content delivery networks (“CDNs”; e.g., Akamai, CloudFlare) have been largely responsible for storing and serving data for Internet applications. Infrastructure in the cloud or a CDN is typically owned by a single provider, making these storage methods unsuitable for dapps. Instead dapps, especially those built over a blockchain (e.g., ERC 721 tokens in Ethereum), directly resort to using the blockchain for storing application data. However, mainstream blockchains are notorious for their poor scalability which limits the range of applications that can be deployed on them. In particular, realizing a decentralized Web that supports sub-second HTTP lookups at scale is infeasible with today's blockchain technology.

To fill this void, a number of recent efforts have designed decentralized peer-to-peer (p2p) data storage networks—such as IPFS, Swarm, the Hypercore protocol, Safe network and Storj. For example, the IPFS network has more than 3 million client requests per week with hundreds of thousands of storage nodes worldwide as part of the network. In these networks, each unique piece of data is stored over a vast network of servers (nodes) with each server responsible for storing only a small portion of the overall stored data unlike blockchains. The networks are also characterized by their permissionless and open nature, wherein any individual server may join and participate in the network freely. By providing appropriate monetary incentives (e.g., persistent storage in IPFS can be incentivized using Filecoin) for storing and serving data, the networks encourage new servers to join which in turn increases the net storage capacities of these systems.

A challenge in the p2p storage networks, as outlined above, is how to efficiently locate where a desired piece of data is stored in the network. Unlike cloud storage, there is no central database that maintains information on the set of files hosted by each server at any moment. Instead, p2p storage networks rely on a distributed hash table (DHT) protocol for storage and retrieval by content addressing data. Recently, Kademlia DHT has emerged as the de facto protocol and has been widely adopted by practitioners. For instance, IPFS, Swarm, Hypercore protocol, Safe network and Storj are all based on Kademlia. To push or pull a data block from the network, the hash of the data block (i.e., its content address) is used to either recursively or iteratively route a query through the DHT nodes until a node responsible for storing the data block is found.

For latency-sensitive content lookup applications, such as the Web where a delay of even a few milliseconds in downloading webpage objects can lead to users abandoning the website, the latency of routing a query through Kademlia should be as low as possible. As such, each Kademlia node maintains a routing table, which contains IP address references to other Kademlia nodes in the network. The sequence of nodes queried while performing a lookup is dictated by the choice of routing tables at the nodes. As noted above, Kademlia implementations choose the routing tables that are completely agnostic of where the nodes are located in the network. As a result, a query in Kademlia may take a route that crisscrosses continents before arriving at a target node costing significant delay. Moreover, the open and permissionless aspects makes the network inherently heterogeneous: nodes can differ considerably in their compute, memory and network capabilities which creates differences in how fast nodes respond to queries; data blocks published over the network vary in their popularity, with demand for some data far exceeding others; the network is also highly dynamic due to peer churn and potentially evolving user demand for data (e.g., a news webpage that is popular today may not be popular tomorrow). Designing routing tables in Kademlia that are tuned to the various heterogeneities and dynamism in the network to minimize content lookup delays is therefore a highly nontrivial task. For example, the proximity neighbor selection (PNS) advocates choosing routing table peers that are geographically close to a node (more precisely, peers having a low round-trip-time (RTT) ping delay to the node), and proximity routing (PR)] favors relaying a query to a matching peer with the lowest RTT in the routing table. While these location-aware variants have been shown to exhibit latency performance strictly superior to the original Kademlia protocol, they are not adaptive to the heterogeneities in the network. PNS is also prone to Sybil attacks which diminishes its practical utility.

It is with respect to these and other considerations that the various aspects and embodiments of the present disclosure are presented.

### SUMMARY

This invention is directed to machine learning inspired decentralized algorithms for constructing the routing tables in Kademlia so that lookup latencies are minimized.

In accordance with an aspect of the disclosure, a method to learn routing table entries at each node in a distributed hash table (DHT) or an overlay protocol is described. The method may include receiving a query at a node in a network; storing data in a routing table at the node pertaining to peers to which the query is routed to; determining a time period that it takes to receive a response at the node from the peers; and determining whether to retain the peers currently in the routing table based on the time period. The method optimizes the routing table to reduce latency. A computing device implementing the method is also described.

In accordance with another aspect of the disclosure, a method is disclosed that includes receiving a dataset on the geographical distribution of nodes in production applications; modelling the propagation delay between any two nodes in relation to the geographical distance between the nodes' locations; and learning from the modelling to optimize a routing table at a node that consists of peers to which queries are to be communicated.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates an example of k-buckets at a node in a network with 4-bit node IDs;

FIG. 1B illustrates an example of a recursive routing path taken to lookup key 0101 where a highlighted node ID is a peer to which the query is forwarded for the next hop;

FIG. 2A illustrates an average latency of queries in each epoch for queries routed through the 1st k-bucket of an arbitrary node;

FIG. 2B illustrates a histogram of lookup latencies in Kadabra during the first and last 1000 rounds in a 10 million query run;

FIG. 3A an average latency during each epoch for queries routed through the 1st k-bucket of an arbitrary node with demand hotspots;

FIG. 3B illustrates performance of a node within a region of high node latency nodes;

FIG. 4A illustrates performance of queries routed through the 1st k-bucket of a node in Frankfurt;

FIG. 4B illustrates histograms of query latencies before and after learning in Kadabra with 10 million lookups;

FIG. 5A illustrates performance when there are demand hotspots;

FIG. 5B illustrates performance when 4% of nodes near New York city have above average node latencies;

FIG. 6A illustrates that Kadabra performance when adversarial nodes are randomly located;

FIG. 6B illustrates Kadabra performance when adversarial nodes are concentrated in one region close to the victim node. Performance is measured at the victim node;

FIG. 7A illustrates 2048 nodes randomly distributed within a square;

FIG. 7B illustrates 2048 nodes at cities around the world where a dot may represent multiple nodes due to high geographic concentration;

FIGS. 8A-8E illustrate a randomly sampled five nodes in the square and compares the performance of Kadabra and the baseline algorithms at each node under uniform demand;

FIGS. 9A-9D illustrate paths and latencies of example lookups wherein Kadabra is trained for 50 epoch under uniform demand and Mᵢ refers to a node that is on the path but is not the source or destination node;

FIGS. 10A-10E illustrate a randomly sampled five nodes in the square and compares the performance of Kadabra and the baseline algorithms at each node under demand hotspots;

FIGS. 11A-11D illustrate paths and latencies of a sample lookup under hotspot demand wherein the source node(S) and the destination node (D) are the same pair of nodes for all protocols and Mᵢ refers to a node that is on the path but is not the source or destination node;

FIG. 12A illustrates performance under uniform demand;

FIG. 12B illustrates performance under demand hotspots;

FIG. 13 illustrates performance when a region of nodes have higher node latencies than average wherein measurements are taken from within the high node latency area;

FIGS. 14A-14E illustrate performance under uniform demand at five randomly sampled nodes around the world;

FIGS. 15A-15E illustrate performance under demand hotspots at five randomly sampled nodes around the world;

FIG. 16A illustrates paths and latencies of a sample query under uniform demand;

FIG. 16B illustrates paths and latencies of a sample query under hotspot demand;

FIG. 17A illustrates nodes in the real world with DHT application

performance under uniform demand;

FIG. 17B illustrates nodes in the real world with DHT application performance under hotspot demand;

FIG. 18 illustrates nodes in the real world with DHT application wherein 4% of nodes have a high node latency compared to network-wide average wherein measurements are taken from one of the nodes within the high node latency area;

FIG. 19 illustrates iterative routing results; and

FIG. 20 illustrates an example computing environment.

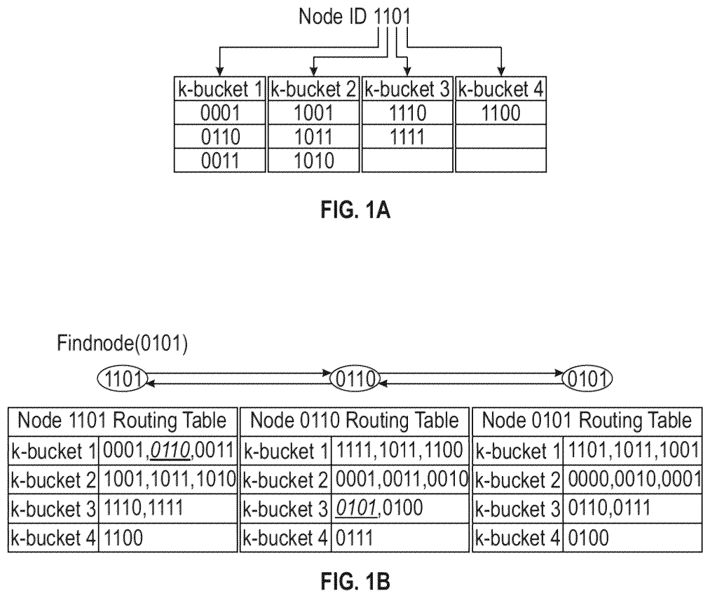

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

A distributed algorithm to learn the routing table entries at each node in Kademlia is provided, to optimize a high-level objective such as number of lookup steps or lookup latency. The learning algorithm uses data about a node's past queries and peer interactions, to tune the routing table at each node to provide the best possible quality of experience for end users. By appropriately choosing the reward signal in the learning algorithm (e.g., overall time taken to perform a lookup), the approach can naturally adapt to the various heterogeneities that exist in the network, including compute and bandwidth differences at nodes, variations in the popularity of different keys etc.

To address the various deficiencies in the prior art, the present disclosure is directed to “Kadabra,” a decentralized, adaptive algorithm for selecting routing table entries in Kademlia to minimize object lookup times (to push or get content) while being robust against Sybil attacks. Kadabra implements a multi-armed bandit (MAB) problem, with each Kademlia node acting as an independent MAB player and the node's routing table configurations being the arms of the bandit problem. By balancing exploring new routing table configurations with exploiting known configurations, a node is able to adaptively discover an efficient routing table that provides fast lookups. Particularly, the discovered routing table configuration at a node is optimized precisely to the pattern of lookups specific to the node. The methods described herein are fully decentralized, relying only on local timestamp measurements for feedback at each node (time between when a query was sent, and its corresponding response received) and does not require any cooperation between nodes.

To protect against Sybil attacks, Kadabra relies on a novel exploration strategy that explicitly avoids including nodes that have a low RTT to a node within the node's routing table with the RTT threshold specified as a security parameter. At the same time, Kadabra's exploration strategy also avoids selecting nodes very far from a node. To accelerate discovery of an efficient routing table configuration, Kadabra decomposes the problem into parallel independent MAB instances at each node, with each instance responsible for optimizing peer entries of a single k-bucket.

### System Model

Consider a Kademlia network over a set of nodes V with each node v∈V having a unique IP address and a node ID from ID space {0, 1}ⁿ. Each node maintains n k-buckets in its routing table, with each k-bucket containing the IP address and node ID of up to k other peers satisfying the ID prefix condition. Consider a set S of (key, value) pairs that have been stored in the network; each (key, value) pair (x, y)∈S is stored in k peers whose IDs are closest to x in XOR distance. Let Sₓ denote the set of keys in S. Time is slotted into rounds, where in each round a randomly chosen node performs a lookup for a certain key. If a node v E V is chosen during a round, it issues a lookup query for key x∈Sₓ where x is chosen according to a demand distribution pᵥ, i.e., pᵥ(x) is the probability key x is queried. A focus of the present disclosure is on recursive routing. When a node v initiates a query for key x, it sends out the query to a closest (to x, in XOR distance) peers in its routing table. For any two nodes u, w, l(u, w)≥0 is the latency of sending or forwarding a query from u to w. When a node w receives a query for key x and it has stored the value for x, the node returns the value back to the node u from whom it received the query.

Otherwise, the query is immediately forwarded to another node that is closest to x in w's routing table. When a node w sends or forwards a value y to a node u, it first takes time δ_{w}≥0 to upload the value over the Internet followed by time l(w, u) for the packets to propagate to u. Thus, for a routing path v, u, w with v being the query initiator and w storing the desired value, the overall time taken for v to receive the value is l(v, u)+l(u, w)+δ_{w}+l(w, u)+δᵤ+l(u, v). The above outlines an example lookup model for the DHT application. For KBR, the same model is followed except only a single query (i.e., a=1) is sent by the initiating node. It is assumed that each node has access to the IP addresses and node IDs of a small number of random nodes in the network. For each of the KBR and DHT applications, the present disclosure describes a decentralized algorithm for computing each node's routing table such that the average time (averaged over the distribution of queries sent from the node) taken to perform a lookup is minimized at the node. Also described are noncooperative algorithms where a node computes its routing table without relying on help from other nodes.

### Kadabra

Kadabra is a fully decentralized and adaptive algorithm that learns a node's routing table to minimize lookup times, purely based on the node's past interactions with the network. Kadabra finds a basis in non-stationary and streaming multi-armed bandit problems applied to a combinatorial bandit setting. A Kadabra node balances efficient routing table configurations it has seen in the past (exploitation) against new, unseen configurations (exploration) with potentially even better latency efficiency. For each query that is initiated or routed through a Kadabra node, the node stores data pertaining to which peer(s) the query is routed to and how long it takes for a response to arrive. This data is used to periodically decide whether to retain peers currently in the routing table, or switch to a potentially better set of peers. Treating the routing table as the decision variable of a combinatorial MAB problem leads to a large space and consequently inefficient learning. Therefore, the problem may be decomposed into n independent subproblems, where the i-th subproblem learns only the entries of the i-th k-bucket. This decomposition is without loss of generality as each query is routed through peers in at most one k-bucket.

The following explains how a Kadabra node can learn the entries of its i-th k-bucket. In Kadabra, a decision on a k-bucket (i.e., whether to change one or more entries of the bucket) is made each time after b queries are routed via peers in the bucket (e.g., b=100 in our experiments). The time between successive decisions on a k-bucket is called as an epoch. Before each decision, a performance score is computed for each peer in the bucket based on the data collected over the epoch for the bucket. Intuitively, the performance score for a peer captures how frequently queries are routed through the peer and how fast responses are received for those queries. By comparing the performance scores of peers in the bucket during the current epoch against the scores of peers in the previous epoch, Kadabra discovers the more efficient bucket configuration which is then used as the k-bucket for the subsequent epoch. To discover new (unseen) bucket configurations, Kadabra also explores random bucket configurations according to a user-defined schedule. In our implementation, one entry on the k-bucket is chosen randomly every other epoch. The overall template of Kadabra is presented in Algorithm 1, below.

Algorithm 1: Algorithm outline for updating entries of i-th k-bucket of node v in each epoch.

| | |
|---|---|
| input : | data [symbol] on queries sent during current epoch; peers Γ_{curr} and Γₚᵣₑᵥ |
| | in k-bucket of current and previous epochs respectively; total score |
| | PrevScoreBucket of previous k-bucket; flag F indicating whether to |
| | explore in next epoch; list [symbol] of peers eligible to be included within |
| | k-bucket; security parameter ρ; |
| output: | updated set of peers Γₙₑₓₜ for next epoch; |

| /* | Score each peer in Γ_{curr} using a scoring algorithm based on | |
|---|---|---|
| | measurements collected during epoch | */ |

score(u) ← SCOREPEER(u, [symbol] ), for each peer u ∈ Γ_{curr}

| if flag F is true then | | | |
|---|---|---|---|
| \| | /* | Replace worst peer with a random peer during next epoch | */ |

| | | |
|---|---|---|
| \| | u* | ← argmin_{u∈Γ} score(u) |

| | |
|---|---|
| \| | Γₙₑₓₜ ← Γ_{curr} \{u*} ∪ SELECTRANDOMPEER( [symbol] , ρ) |

else

| \| | /* | Choose best peer set between current and previous epoch as | |
|---|---|---|---|
| \| | | decision for next epoch | */ |

| \| | if SCOREBUCKET(Γ_{curr}, [symbol] ) > PrevScoreBucket then | |
|---|---|---|
| \| | \| | Γₙₑₓₜ ← Γ_{curr} |
| \| | else | |
| \| | \| | Γₙₑₓₜ ← Γₚᵣₑᵥ |

| | |
|---|---|
| \| | end |

end

### Scoring Function

During an epoch with k-bucket Γ curr, let q₁, q₂, . . . , qᵣ be the set of queries that have been sent or relayed through one or more peers in the k-bucket. For each query qᵢ, 1≤i≤r, let dᵢ(u)≥0 be the time taken to receive a response upon sending or forwarding the query through peer u for u∈Γ curr. If qᵢ is not sent or forwarded through a peer u∈Γ curr we let di(u)=Δ where Δ≥0 is a user-defined penalty parameter. A large value for Δ causes Kadabra to favor peers that are frequently used in the k-bucket, while a small value favors peers from which responses are received quickly. Δ may be a value that is slightly larger than the moving average of latencies of lookups going through the bucket. The function ScoringFunction(u, D) to compute the score for a peer u is then defined as score(u)=ScoringFunction(u, D)=The overall score for the k-bucket is then given as ScoreBucket(Γ curr, D)=−u∈Γ curr score(u)/|Γ curr|. For a k-bucket that is empty, its score is defined to be −Δ.

### Random Exploration

To discover new k-bucket configurations with potentially better performance than past configurations, a Kadabra node includes randomly selected peers within its bucket through the SelectRandomPeer( ) function as outlined in Algorithm 1. The Kadabra node maintains a list L of peers eligible to be included within its k-bucket, which satisfy the required node ID prefix conditions. In addition to the peer IP addresses, it is assumed the node also knows the RTT to each peer in the list. For a random exploratory epoch, the node replaces the peer having the worst score from the previous epoch with a randomly selected peer from the list. The number of peers in the bucket that are replaced with a random peers can be configured to be more than one more generally.

An example contribution in Kadabra is how peers are sampled from the list of known peers to be included in the k-bucket. Depending on the number of nodes in the network, and the index of the k-bucket, the number of eligible peers can vary with some peers close to the node while some farther away (in RTT sense). A naive approach of sampling a node uniformly at random from the list, can eventually lead to a bucket configuration in which all peers are located close to the node. This is due to the algorithm ‘discovering’ the proximity neighbor selection (PNS) protocol which has been demonstrated to have efficient latency performance compared to other heuristics. However, as with PNS, the routing table learned with a uniformly random sampling strategy is prone to a Sybil attack as it relatively inexpensive to launch a vast number of Sybil nodes concentrated at a single location close to a victim node(s). While the PNS peer selection strategy may not have an efficient performance in all scenarios (e.g., if the node upload latencies are large), in cases where it does, Kadabra may be susceptible to attack. Therefore, routing table configuration is learned in which not all peers are located close to the node. Such a routing table configuration may not be performance efficient (e.g., PNS may have a better latency performance in certain scenarios) but is more secure compared to PNS.

This aspect of the disclosure is taught by introducing a security parameter p≥0, that is user-defined, to restrict the choice of peers that are sampled during exploration. For a chosen ρ value, a Kadabra node computes a subset L>ρ⊆L of peers to whom the RTT is greater than ρ from the node. The SelectRandomPeer(L, ρ) then samples a peer uniformly at random from L>ρ. A high value for ρ selects peers that are at a distance from the node, providing security against Sybil attacks at a cost of potentially reduced latency performance (and vice-versa).

### Evaluation

Kadabra was evaluated using a custom discrete-event simulator built on Python following the model presented above. As noted above, an aspect of Kadabra is how to configure the routing table, thus the algorithm is compared against the following baselines with differing (i) routing table (bucket) population mechanisms, and (ii) peer selection methods during query forwarding:
(1) Vanilla Kademlia—The original Kademlia protocol in which a node populates its buckets by randomly adding peers from node ID ranges corresponding to the buckets. When forwarding a query, the node chooses the peer whose node ID is closest (in XOR distance) to the query's target node ID from the appropriate bucket.
(2) Proximity routing—In PR buckets are populated exactly as in vanilla Kademlia. However, when routing a query, the query is sent to the peer in the appropriate k-bucket that is closest to the node in RTT.
(3) Proximity neighbor selection (PNS)—In PNS the node picks peers which are closest to itself (in terms of RTT) from among eligible peers to populate each k-bucket. When forwarding a query, the node chooses the peer whose node ID is closest to the target node ID from the appropriate bucket.

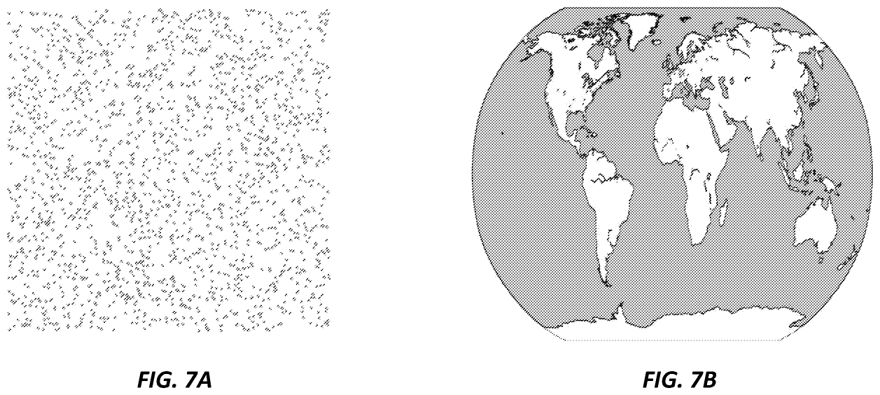

Two network scenarios are considered, one where nodes are distributed over a two-dimensional Euclidean space, and the other where nodes distributed over a real-world geography (see, FIGS. 7A and 7B).
(1) Nodes in a square (FIG. 7A). In this setting, 2048 nodes are assigned random locations within a 10000×10000 square. The latency l(u, v) between any two nodes u, v is given by l(u, v)=|u−v|2+w(u, v), where |u−v|2 is the Euclidean distance between u and v on the square and w(u, v) is random perturbation from a uniform distribution between 100 and 5000. Each node has a node latency (δ in § 3) sampled uniformly between 100 and 2000.
(2) Nodes in the real world (FIG. 7B). We again consider 2048 nodes located in various cities around the world, as reported by Ethereum node tracker. The latency between nodes in any pair of cities is obtained from a global ping latency measurement dataset. Each node has a node latency sampled from an exponential distribution of mean 1000 ms.

The KBR application is considered under the following three traffic patterns:
(1) KBR under uniform demand. In this setting, a node during a round issues a lookup to another node chosen uniformly at random from among the available nodes.
(ii) KBR under demand hotspots. In this setting, there are 20% of keys (nodes) that form the target destination for 80% of lookups. The hotspot nodes are randomly chosen.
(3) KBR under skewed network bandwidth. To model regions around the world with poor Internet speeds, we consider a subset of geographically close nodes whose node upload latencies are twice as large as the average node latency in the network.

### Results—Nodes in a Square

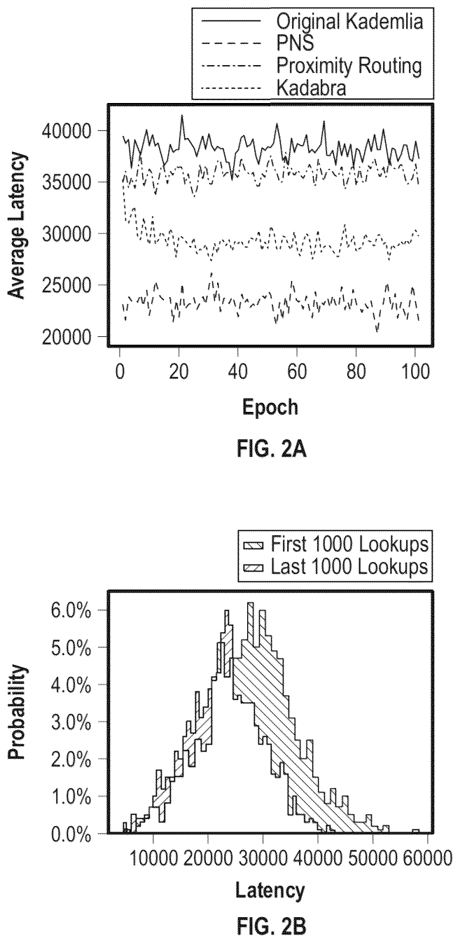

FIG. 2A plots the average latency between forwarding a query through the 1st k-bucket and receiving a response during each epoch for an arbitrarily chosen node within the square. It is observed that starting with a randomly chosen routing table configuration (at epoch 0), Kadabra continuously improves its performance eventually achieving latencies that are 15% better. Compared to the latencies in the original Kademlia protocol, Kadabra's latencies are lesser by more than 20%. For this specific network setting, PNS shows the best performance (at the cost of poor security). ρ values of [400, 350, 300, 250, 200, 150, 100, 50, 0] have been used for the different k-buckets (1st to last) in Kadabra, which results in slightly higher latencies compared to PNS.

To show that all nodes in the network benefit from Kadabra, an experiment lasting for 10 million rounds (1 query per round from a random source to a random destination) was used, with the sequence of first 1000 queries being identical to the sequence of the last 1000 queries. FIG. 2B plots a histogram of the query latencies for the first and last 1000 queries in Kadabra. The 90th percentile latency of Kadabra during the last 1000 queries is lesser than that in the beginning by more than 24%.

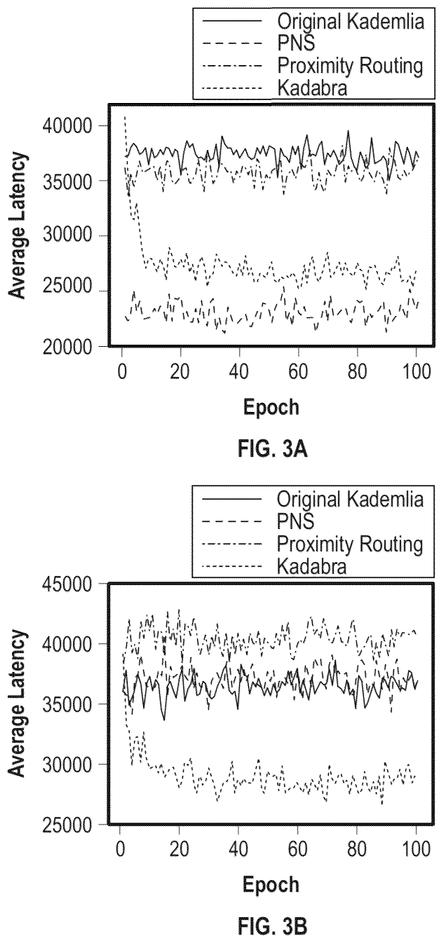

FIG. 3A shows the average query latency over epochs for queries routed through the 1st k-bucket of an arbitrary node under hotspot demand. With certain keys being more popular than others, Kadabra adapts the node routing tables biasing them for fast lookups of the popular keys, which is a capability that is distinctly lacking in the baselines. As a result, Kadabra outperforms the original Kademlia and PR by more than 25%.

To show that Kadabra adapts to variations in the Internet capacities of nodes, an experiment is considered where nodes within an area (2000×2000 region in the center of the square) alone have a higher node latency (5000 time units) than the default node latency values. This setting models, for instance, low-income countries with below-average Internet speeds. For a node within the high node latency region, PNS ends up favoring nearby peers also within that region which ultimately severely degrades the overall performance of PNS (see, FIG. 3B). Kadabra, on the other hand, is cognizant of the high node latencies in the region and discovers k-bucket entries that provide more than 25% improvement in latency performance compared to PNS.

### Results—Nodes in the Real World

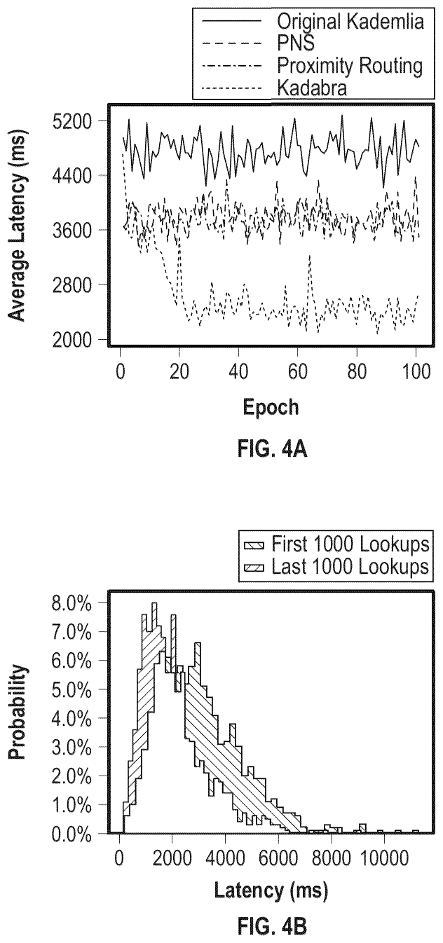

Unlike the square setting where nodes are uniformly spread out, in the real-world setting nodes are concentrated around certain regions in the world (e.g., Europe or North America). Moreover, the node latencies are also chosen to reflect retrieval of large files. FIG. 4A shows the latencies for queries routed through the 1st k-bucket of an arbitrary node (in this case, the node is located in Frankfurt). Kadabra has 50% lower latencies compared to the original Kademlia protocol and 35% lower latencies compared to PNS and PR. This is because the baseline algorithms are not aware of the different node latencies of the peers, whereas Kadabra is able to focus its search on peers having low node latencies. As in the square case, FIG. 4B shows the benefit of Kadabra extends to the entire network.

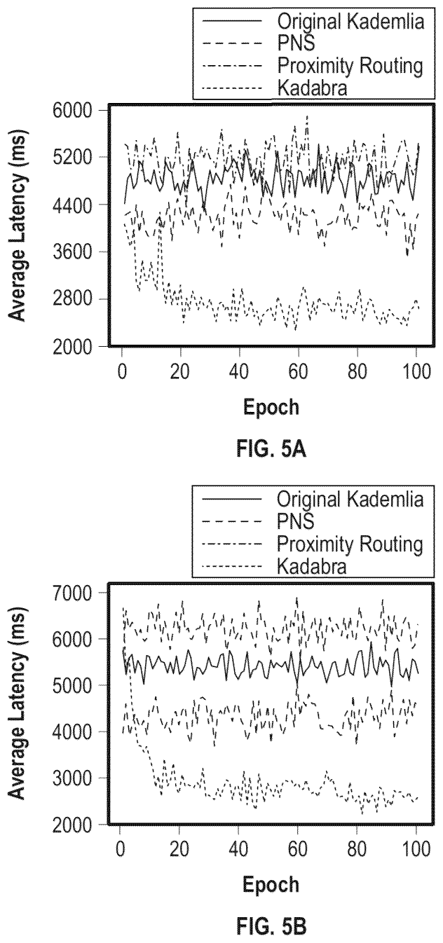

FIG. 5A shows performance when there are demand hotspots. Compared to uniform demand, both PNS and PR worsen in performance increasing the gap to Kadabra. A similar trend is observed in FIG. 5B when a region of nodes is considered (near New York city in the experiments) and set their node latency to double the default average value. While even Kadabra shows a slight degradation, it is still more than 40% more efficient compared to PNS.

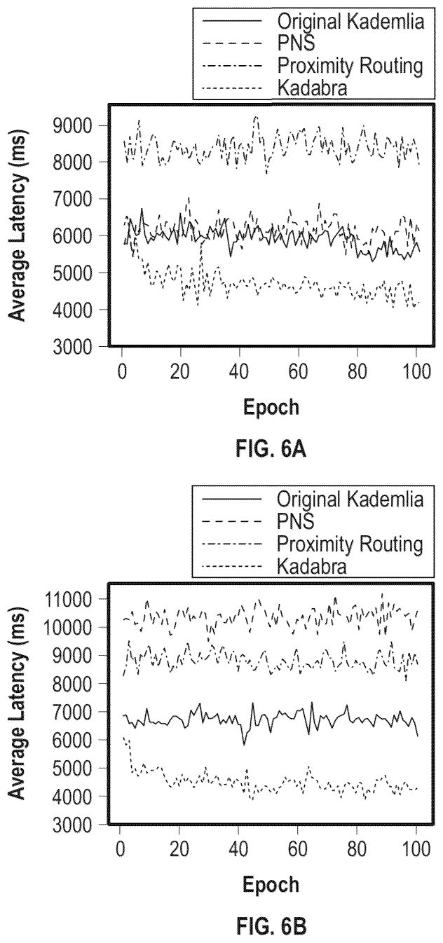

In addition, the security of Kadabra is evaluated by setting 20% of the nodes as adversarial, which deliberately delay queries passing through them by 3× their default node latencies. While all algorithms degrade in this scenario, FIG. 6A shows that when the adversarial nodes are located at random cities Kadabra discovers routes which avoid the adversarial nodes resulting in overall quicker lookups. Even when the adversarial nodes are concentrated in one region close to a victim node, FIG. 6B shows how a victim running Kadabra can effectively bypass the adversarial nodes while PNS takes a huge performance loss at more than 2× the latency of Kadabra.

### Results—Nodes in a Square KBR

In this section, we present additional results for the KBR application when nodes are distributed randomly on a square.

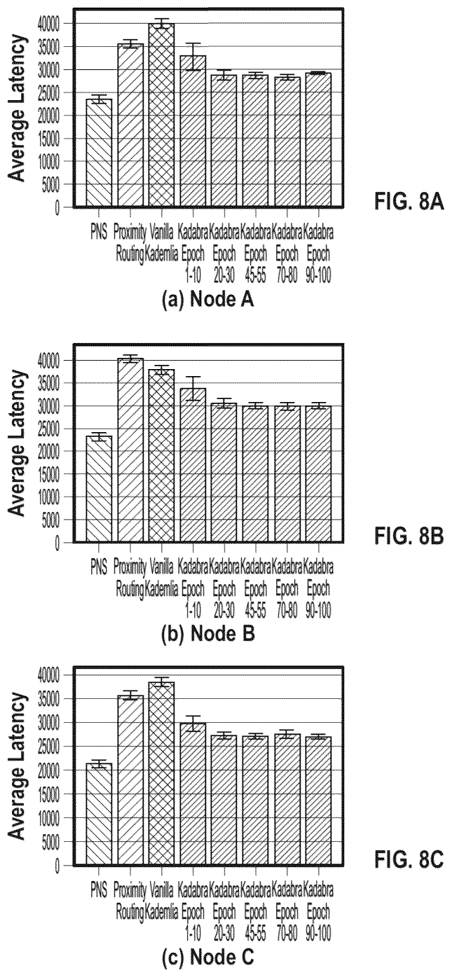

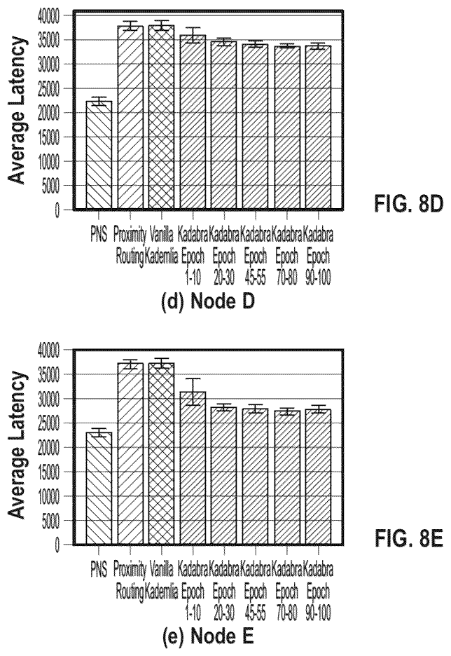

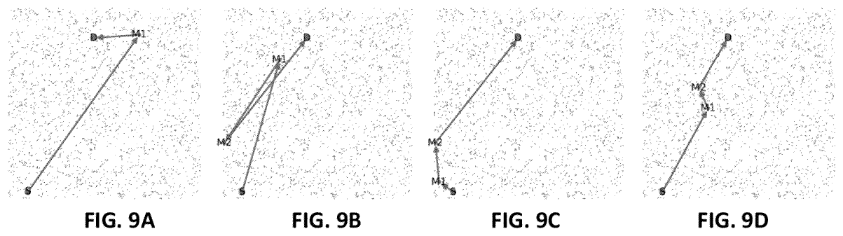

For uniform traffic demand we have presented how the average latency varies with epochs for an arbitrarily chosen node. To show that the presented behavior is general, and not occurring only at a few nodes, in FIG. 8 we show performance of Kadabra and baselines at five randomly chosen nodes. In all cases, we observe a similar qualitative behavior. FIG. 9 presents an example of the paths taken for a lookup from the same source to the same destination on different heuristics. Kadabra is able to achieve significantly lower path latency by choosing a relatively straight path with low node latencies. In the figure, node D's node latency is 1000. For vanilla Kademlia, node M1's node latency is 1400. For PR, node M1's node latency is 800 and M2's node latency is 1400. For PNS, node M1's node latency is 2000 and M2's node latency is 1400. For Kadabra, node MI's node latency is 100 and M2's node latency is 100.

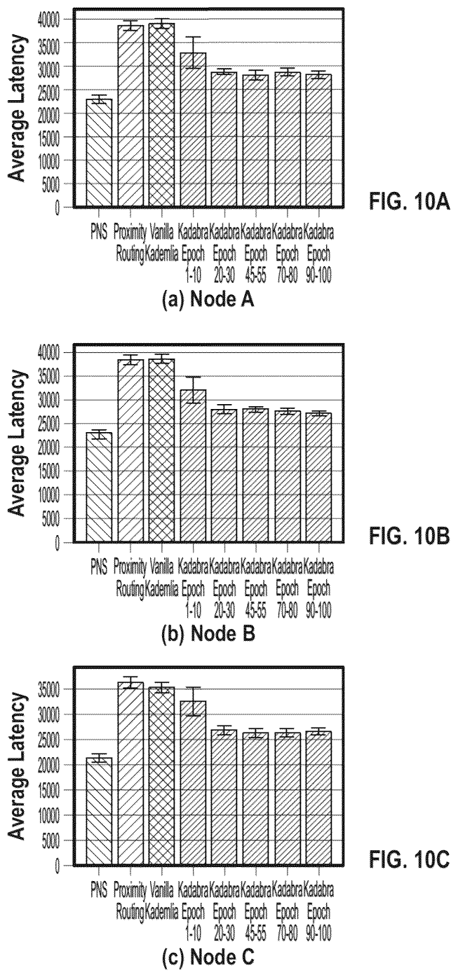

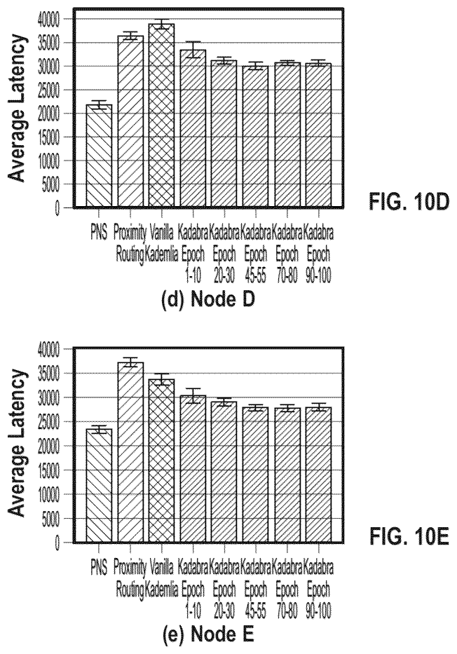

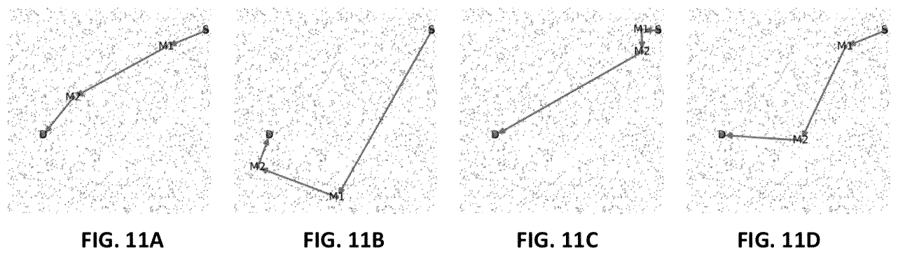

Similarly, in FIG. 10 we plot the performance under hotspot demand measured from five randomly chosen nodes. Here too, we observe the qualitative behavior is the same across the five nodes. FIG. 11 shows the paths taken by the different heuristics on the same sample query. Kadabra has been trained for 50 epochs. We observe Kadabra's path latency is >25% more efficient than the original Kademlia protocol. In the figure, node D's node latency is 800. For vanilla Kademlia, node M1's node latency is 400 and node M2's node latency is 1100. For PR, node M1's node latency is 100 and node M2's node latency is 1800. For PNS, node M1's node latency is 1700 and node M2's node latency is 1200. For Kadabra, node Ml's node latency is 400 and node M2's node latency is 400.

### Results—Nodes in a Square DHT

Next, we consider the DHT application in which a (key, value) pair is stored on 3 nodes. When a node initiates a query for the key, it sends out queries on α=2 independent paths. The overall latency lookup latency is the time between sending out the queries and the earliest time when a response arrives on any of the paths. As in the KBR application, we consider three traffic settings:
(1) DHT under uniform demand.
(2) DHT under demand hotspots.
(3) DHT under skewed network bandwidth.

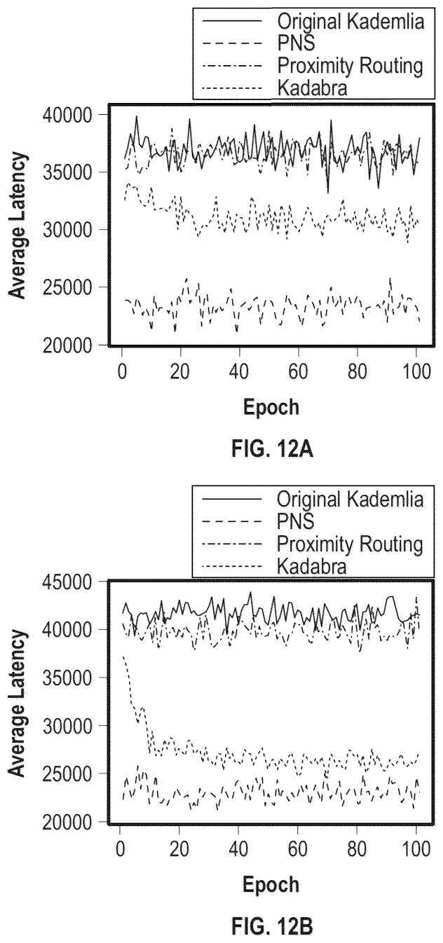

These settings are similar to the KBR case, and hence we do not elaborate them. FIGS. 12A and 12B show the performance, at an arbitrarily chosen node, of queries sent through the 1st k bucket under uniform demand and hotspot demand respectively. Similar to KBR, with hotspot nodes, the improvement we gain from Kadabra is larger than the scenario without hotspot nodes.

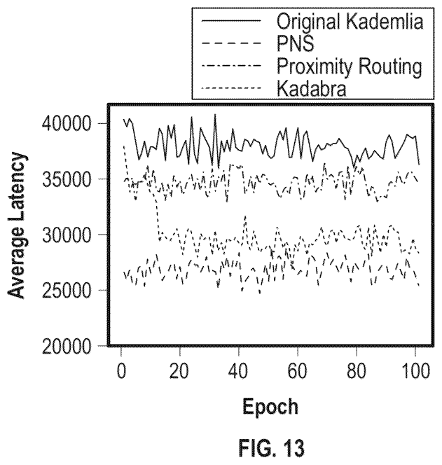

FIG. 13A shows the case where nodes within a small 2000×2000 region at the center of the square have high node latencies than default values. Unlike KBR, in the DHT case PNS and Kadabra are much closer.

### Results—Nodes in the Real World KBR

In this section, we provide supplementary results for the cases considered under KBR application when nodes are distributed over a real world geography.

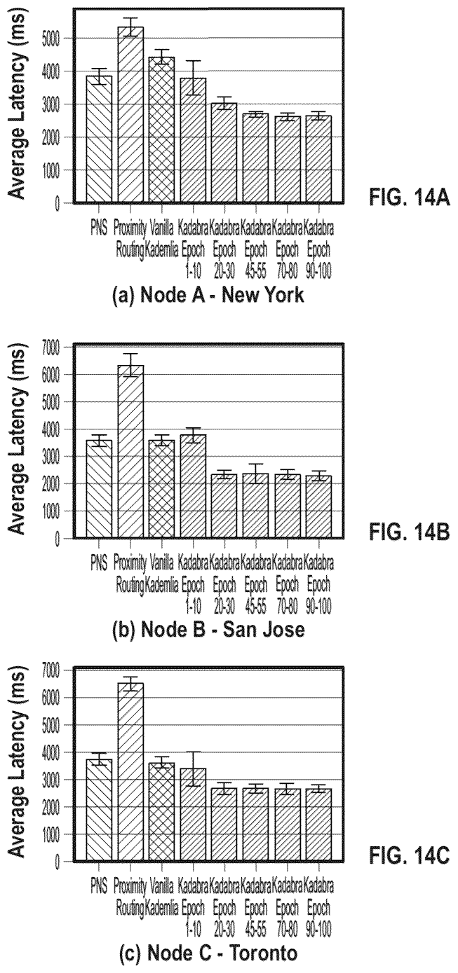

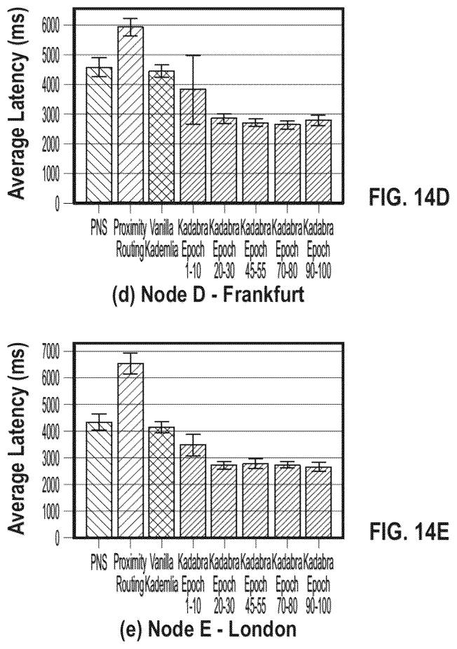

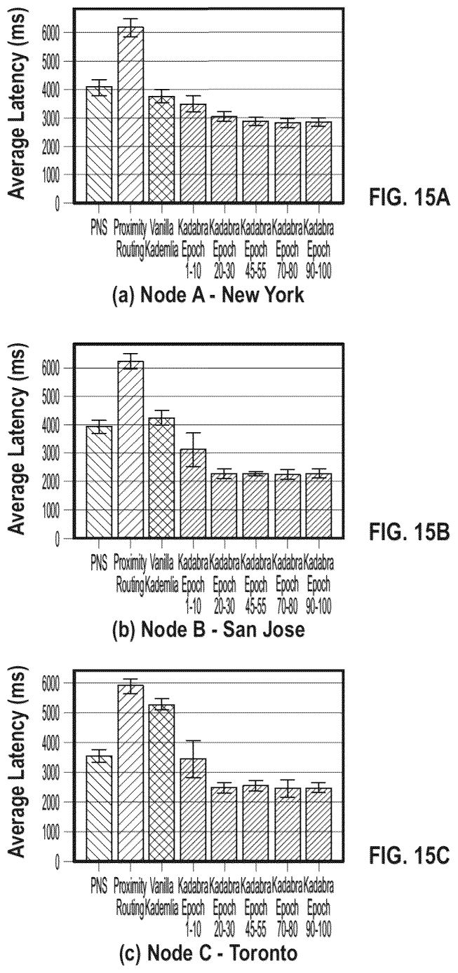

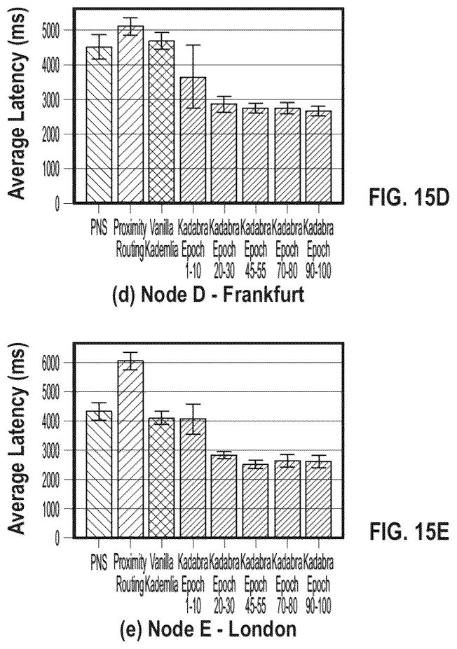

FIGS. 14 and 15 show performance at five randomly chosen nodes, for uniform demand and hotspot demand settings. The behavior observed in these plots are consistent with our discussion above.

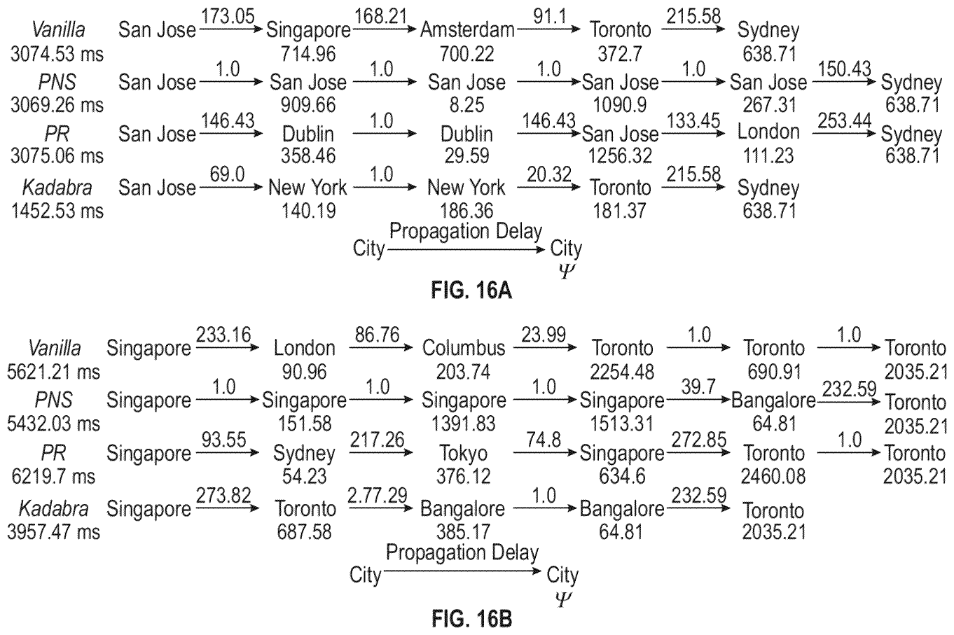

FIGS. 16A and 16B show the paths and their corresponding latencies of a sample query, under uniform traffic and hotspot traffic respectively. Some cities are repeated on the paths are there may be multiple nodes within the same city. The latency between two nodes in the same city is set to 1 ms in our experiments. Compared to baselines, Kadabra chooses efficient paths with a fewer number of hops and low node and link latencies.

### Results—Nodes in the Real World DHT

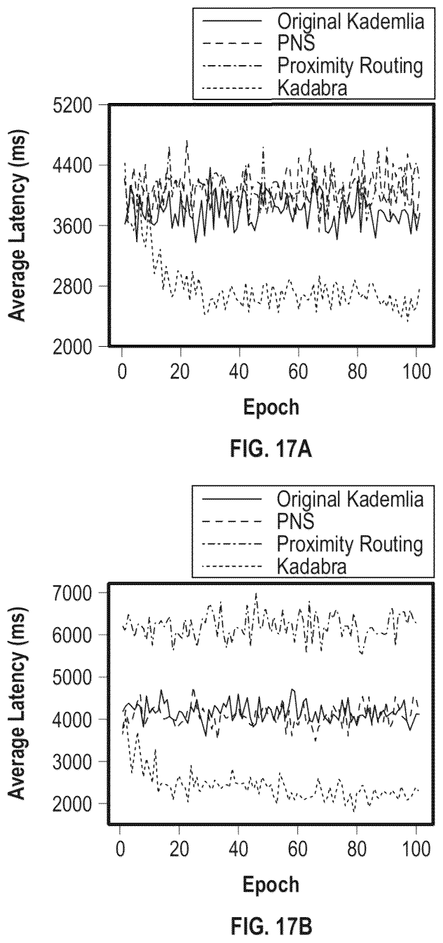

This section considers the DHT application for the setting of nodes in the real world. FIGS. 17A and 17B show performance under uniform traffic and hotspot traffic demands respectively. In each case, Kadabra is exhibits lower latencies than the baselines. Kadabra is more than 30% faster compared to PNS in the two cases.

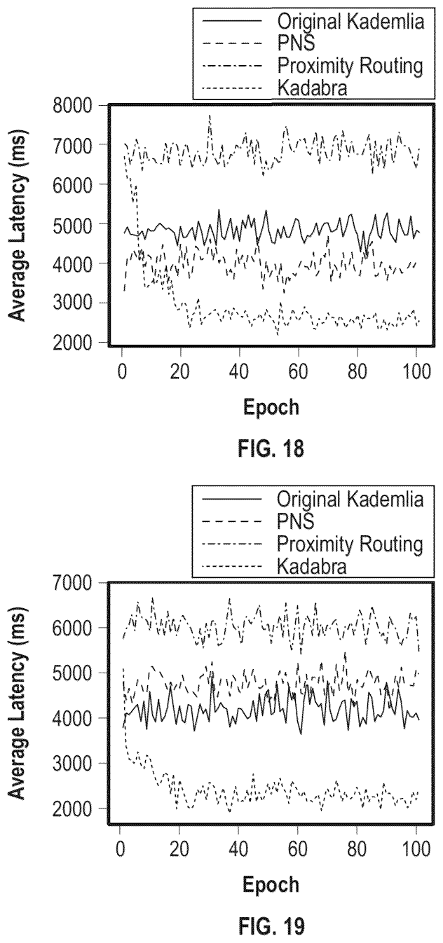

FIG. 18A considers a setting where a region of nodes around New York have node latency that is twice the default average value. Here too, we observe Kadabra outperforms the other baselines.

### Results—Iterative Routing

There are two options when it comes to routing in Kademlia: recursive routing and iterative routing. In recursive routing, the source node contacts the first hop node, and the first hop node then contacts the second hop node. In iterative routing, the first hop node returns the second hop node information to the source node, and the source node contacts the second hop node by itself. Although most current Kademlia implementations use recursive routing, vanilla Kademlia uses iterative routing. In our evaluations we have mainly discussed recursive routing. In this section, we consider iterative routing under uniform traffic demand when nodes are located on the real world. The result is shown in FIG. 19, where Kadabra outperforms the baselines. Thus, Kadabra is a robust algorithm that can adapt to a wide variety of situations.

### EXAMPLE COMPUTING ENVIRONMENT

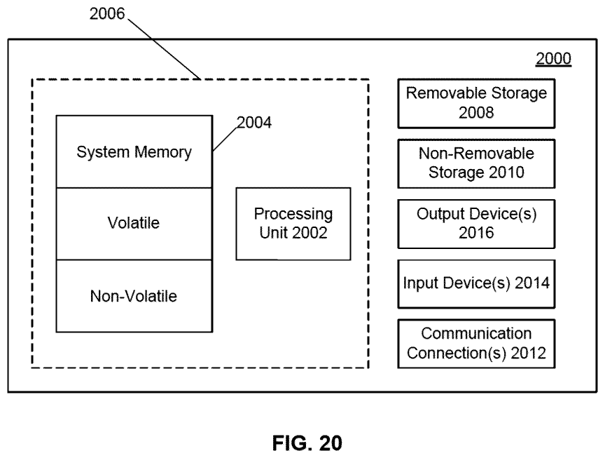

FIG. 20 shows an example, non-limiting, computing environment in which example embodiments and aspects may be implemented. The computing environment is only one example of a suitable computing environment and is not intended to suggest any limitation as to the scope of use or functionality.

Numerous other general purpose or special purpose computing devices environments or configurations may be used, such as, but not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 20, an exemplary system for implementing aspects described herein includes a computing device, such as computing device 2000. In its most basic configuration, computing device 2000 typically includes at least one processing unit 2002 and memory 2004. Depending on the exact configuration and type of computing device, memory 2004 may be volatile (such as random access memory (RAM)), non-volatile (such as read-only memory (ROM), flash memory, etc.), or some combination of the two. This most basic configuration is illustrated in FIG. 20 by dashed line 2006.

Computing device 2000 may have additional features/functionality. For example, computing device 2000 may include additional storage (removable and/or non-removable) including, but not limited to, magnetic or optical disks or tape. Such additional storage is illustrated in FIG. 20 by removable storage 2008 and non-removable storage 2010.

Computing device 2000 typically includes a variety of computer readable media. Computer readable media can be any available media that can be accessed by the device 2000 and includes both volatile and non-volatile media, removable and non-removable media.

Computer storage media include tangible volatile and non-volatile, and removable and non-removable media implemented in any method or technology for storage of information such as computer readable instructions, data structures, program modules or other data. Memory 2004, removable storage 2008, and non-removable storage 2010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 2000. Any such computer storage media may be part of computing device 2000.

Computing device 2000 may contain communication connection(s) 2012 that allow the device to communicate with other devices. Computing device 2000 may also have input device(s) 2014 such as a keyboard, mouse, pen, voice input device, touch input device, etc. Output device(s) 2016 such as a display, speakers, printer, etc. may also be included. All these devices are well known in the art and need not be discussed at length here.

As used herein, the singular form “a,” “an,” and “the” include plural references unless the context clearly dictates otherwise.

As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, IoT and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Numerous characteristics and advantages provided by aspects of the present invention have been set forth in the foregoing description and are set forth in the attached Appendices A and B, together with details of structure and function. While the present invention is disclosed in several forms, it will be apparent to those skilled in the art that many modifications can be made therein without departing from the spirit and scope of the present invention and its equivalents. Therefore, other modifications or embodiments as may be suggested by the teachings herein are particularly reserved.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method to learn routing table entries at each node in a distributed hash table (DHT) or an overlay protocol, comprising:
receiving a query at a node in a network;
storing data in a routing table at the node pertaining to peers to which the query is routed to;
determining a time period that it takes to receive a response at the node from the peers; and
determining whether to retain the peers currently in the routing table based on the time period,
wherein the routing table is optimized to reduce latency.

2. The method of claim 1, wherein the method comprises an algorithm, wherein the algorithm is a distributed algorithm or a decentralized algorithm.

3. The method of claim 2, wherein the algorithm is configured to optimize a number of lookup steps or lookup latency.

4. The method of claim 2, wherein the algorithm is configured to use data about a node's past queries and peer interactions, to tune the routing table at each node.

5. The method of claim 2, wherein the algorithm is configured to adapt to heterogeneities that exist in the network, including compute and bandwidth differences at nodes and variations in the popularity of different keys.

6. The method of claim 2, wherein the algorithm is a learning algorithm.

7. The method of claim 6, wherein the learning algorithm is configured to construct routing tables to minimize lookup latencies.

8. The method of claim 6, wherein the learning algorithm is configured to use peer sequences and round-trip-times (RTTs) of lookups performed in the recent past by a node v to decide the entries of node v's routing table.

9. The method of claim 6, wherein the learning algorithm is configured to determine a tradeoff between round-trip-time (RTT) and frequency of occurrence in peer sequences to provide a lowest average lookup latency.

10. The method of claim 1, wherein the DHT or the overlay protocol is Kademlia.

11. A method comprising:
receiving a dataset on the geographical distribution of nodes in production applications;
modelling the propagation delay between any two nodes in relation to the geographical distance between the nodes' locations; and
learning from the modelling to optimize a routing table at a node that consists of peers to which queries are to be communicated.

12. The method of claim 11, wherein the model is for a Kademlia system.

13. The method of claim 12, further comprising storing and retrieving objects on the Kademlia system where the object size is not larger than a few kilobytes.

14. The method of claim 11, wherein the modelling is used to determine effects of wide area propagation latencies and node processing delays on performance.

15. The method of claim 14, wherein the learning is configured to optimize the routing table by minimizing lookup latencies.

16. A computing device that communicates with peer nodes on a network, comprising:
a processor;
a memory that stores computer executable instructions that when executed by the processor performs operations that comprise:
receiving a query over the network;
storing data in a routing table pertaining to the peer nodes to which the query is routed over the network;
determining a time period that it takes to receive a response from the peer nodes; and
determining whether to retain the peer nodes currently in the routing table based on the time period in order to optimize the routing table to reduce latency.

17. The computing device of claim 16, wherein data about a node's past queries and peer interactions are used to tune the routing table at each node.

18. The computing device of claim 16, wherein the routing table is adapted to heterogeneities that exist in the network, including compute and bandwidth differences at nodes and variations in the popularity of different keys.

19. The computing device of claim 16, peer sequences and round-trip-times (RTTs) of lookups performed in a recent past by a node v are used to decide entries of node v's routing table.

20. The computing device of claim 19, a tradeoff between round-trip-time (RTT) and frequency of occurrence in peer sequences is determined to provide a lowest average lookup latency.
